(19) United States
(12) Patent Application Publication
(10) Pub. No.: US 2002/0144526 A1
(43) Pub. Date: Oct. 10, 2002

(54) On electronic lock

(76) Inventor: Chen Ming-Chih, Taichung City (TW)

Correspondence Address: LAW OFFICE OF LIAUH & ASSOC., 4224 WAIALAE AVE, STE 5-388, HONOLULU, HI, 96816

(21) Appl. No.: 09/832,224

(22) Filed: Apr. 9, 2001

(51) Int. Cl. E05B 13/00; E05B 47/00

(52) U.S. Cl. 70/218; 70/276; 70/277

(57) ABSTRACT

An electronic lock comprises a magnetic induction mechanism, a clutch mechanism, a lock core mechanism linked with one end of the clutch mechanism, and a rotation mechanism linked with other end of the clutch mechanism. The magnetic induction mechanism is formed of a permeable outer iron piece, a permeable inner iron piece, a permanent magnet located between the outer iron piece and the inner iron piece for generating an auxiliary magnetic field, and an induction coil held by the inner iron piece for generating an induction magnetic field. The clutch mechanism is activated by a combined force of the auxiliary magnetic field and the induction magnetic field.

### FIELD OF THE INVENTION

The present invention relates generally to an electronic lock, and more particularly to a durable and energy-efficient electronic lock.

### BACKGROUND OF THE INVENTION

The ON-OFF action of the electronic circuit of an electronic lock is triggered by an input instruction to result in an electromagnetic induction by means of which the control of the clutch is effected. The mechanism that works to unlock the electronic lock is mechanically brought about. The input of the instruction is brought about by means of keyboard, fingerprint identification card, induction key, etc. As a correct instruction is entered, the circuit of the electronic lock is turned on such that an electromagnetic induction is generated by the induction coil of the electronic lock. The power source of the electronic lock is battery.

This inventor of the present invention discloses an electronic lock in the U.S. Pat. Ser. No. 09/431,682. As illustrated in FIGS. 1 and 2, the electric current is made available to an induction coil 1 of the electronic lock in the wake of the input of a correct command into the electronic lock, thereby resulting in a magnetic field which causes an action piece 2 to displace. In the meantime, the action piece 2 actuates an actuation block 3 to displace to engage a retaining block 6 which is located in a lock belly 5 of a door body 4. As a doorknob 7 is acted on, a lock tongue 8 of the lock belly 5 is released to open the door body 4. In the meantime, the power supply is terminated. As a result, no more magnetic field is generated by the induction coil 1. The action piece 2 and the actuation block 3 are forced by the spring force of a spring 9 to return to their original positions, thereby resulting in the disengagement of the actuation block 3 with the retaining block 6 of the lock belly 5. The doorknob 7 is thus kept in the idle state to prevent the lock from being opened. In light of the action piece 2 being located strategically, the electronic lock can not be easily tampered with by means of a strong magnetic force. This electronic lock is deficient in design in that it consumes a great deal of energy to drive the action piece 2.

### SUMMARY OF THE INVENTION

The primary objective of the present invention is to provide an energy-efficient electronic lock.

In keeping with the principle of the present invention, the foregoing objective of the present invention is attained by the electronic lock comprising a magnetic induction mechanism, which is provided with a permanent magnet, an outer iron piece, and an inner iron piece. The permanent magnet is contained in the outer iron piece such that the inner iron piece is put on top of the permanent magnet. In light of the magnetic permeability of the inner iron piece and the outer iron piece, the magnetic field of the permanent magnet can establish magnetic induction in the magnetic poles of the inner iron piece and the outer iron piece, thereby resulting in formation of an auxiliary magnetic field. In addition, an induction coil is disposed between the annular projection of the inner iron piece and the outer iron piece for generating an electromagnetic field. The auxiliary magnetic field reduces the amount of the electric current that is needed to bring about the induction magnetic field strong enough to effect the action of the clutch mechanism of the electronic lock.

The features and the functions of the present invention will be more readily understood upon a thoughtful deliberation of the following detailed description of a preferred embodiment of the present invention in reference to the accompanying drawings.

### BRIEF DESCRIPTION OF THE DRAWINGS

FIG. 1 shows a schematic view of the electromagnetic induction of an electronic lock of the prior art in action.

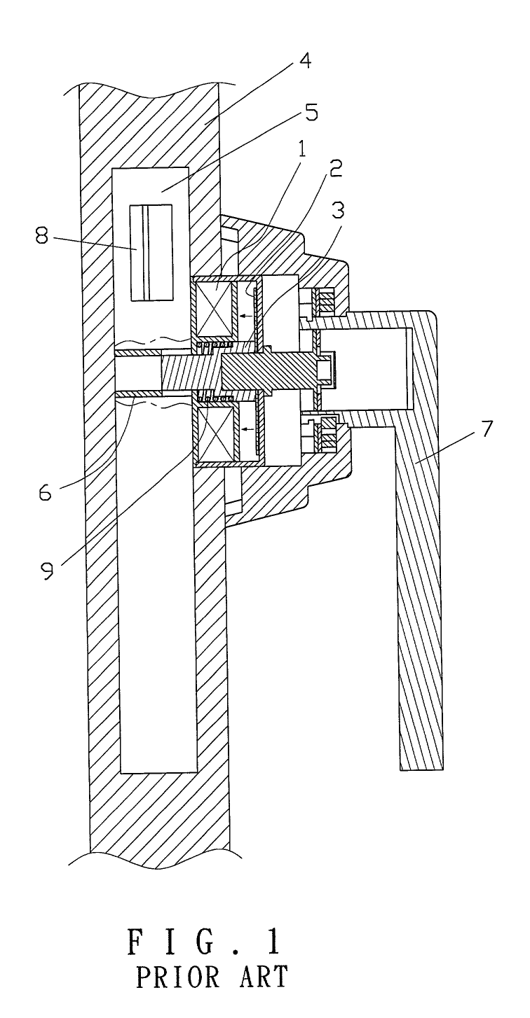

FIG. 2 shows another schematic view of the electromagnetic induction of the electronic lock of the prior art in action.

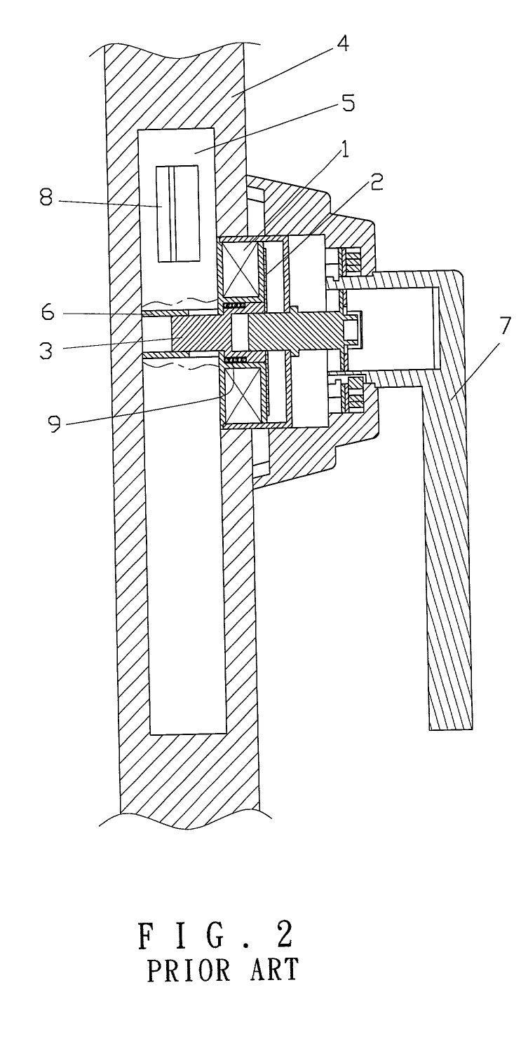

FIG. 3 shows an exploded view of the preferred embodiment of the present invention.

FIG. 4 shows a sectional view of the preferred embodiment of the present invention in combination.

FIG. 5 shows a schematic view of the preferred embodiment of the present invention in action.

FIG. 6 shows another schematic view of the preferred embodiment of the present invention in action.

### DETAILED DESCRIPTION OF THE PREFERRED EMBODIMENT

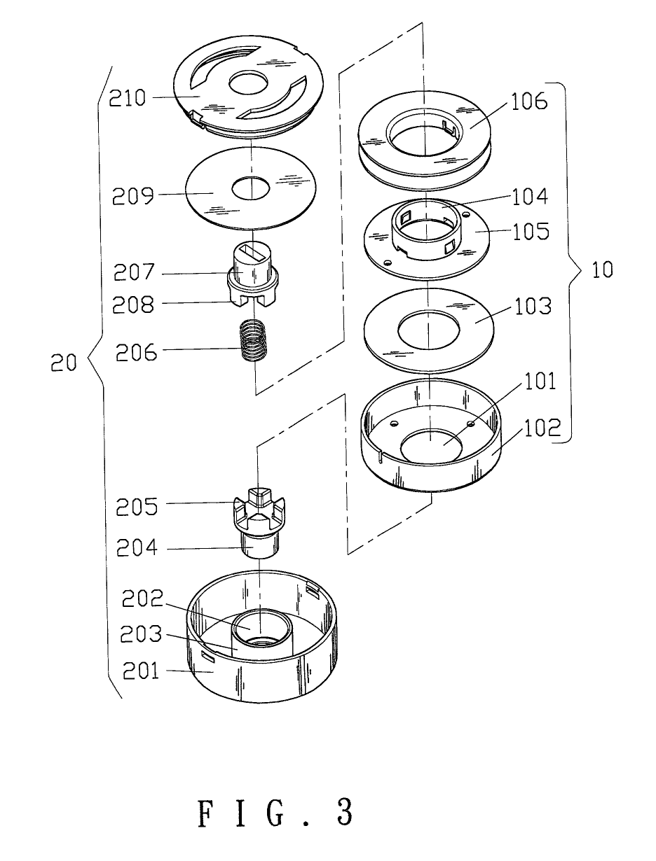

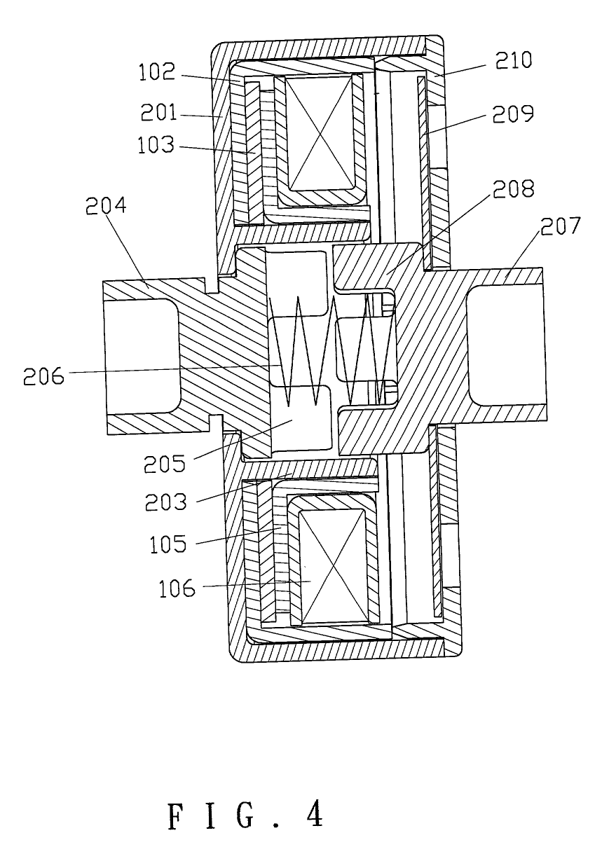

As shown in FIGS. 3-6, an electronic lock embodied in the present invention comprises a magnetic induction mechanism 10, a clutch mechanism 20, a lock core mechanism 30, and a rotation mechanism 40.

The magnetic induction mechanism 10 comprises an annular outer iron piece 102, and annular permanent magnet 103, an annular inner iron piece 105, and an induction coil 106. The outer iron piece 102 is provided with a center hole 101. The permanent magnet 103 is contained in the outer iron piece 102 such that the inner iron piece 105 is disposed on top of the permanent magnet 103. The inner iron piece 105 is provided in the center of the upper surface thereof with an annular projection 104 over which the induction coil 106 is fitted. In light of the permeability of the inner iron piece 105 and the outer iron piece 102, the magnetic field of the permanent magnet 103 can establish magnetic induction in the magnetic poles of the inner iron piece 105 and the outer iron piece 102. As soon as the electric current is made available to the induction coil 106, the induction coil 106 generates an induction magnetic field. As a result, the magnetic poles of the inner iron piece 105 and the outer iron piece 102 have a magnetic field intensity which is the sum of the magnetic field of the permanent magnet 103 and the induction magnetic field of the induction coil 106.

The clutch mechanism 20 comprises an impermeable housing 201 which is provided in the center with a cylindrical projection 203. The cylindrical projection 203 is provided with a stepped hole 202. A stepped shank has a retaining block 204 which is provided at one end with a plurality of retaining teeth 205. Another stepped shank has an engagement block 207 which is provided at one end with a plurality of retaining teeth 208 opposite in location to the retaining teeth 205 of the retaining block 204. A spring 206 is disposed between the retaining block 204 and the engagement block 207. A metal action piece 209 is held by the stepped shank of the engagement block 207 such that the action piece 209 is located in the magnetic field range of the inner iron piece 105 and the outer iron piece 102. The magnetic induction mechanism 10 and the clutch mechanism 20 are held in the housing 201 whose open top is covered by a cover 210. The action piece 209 is displaced by the magnetic field of the magnetic induction mechanism 10, thereby resulting in the engagement of the engagement block 207 with the retaining block 204. The magnetic induction mechanism 10 has an auxiliary magnetic field which is brought about by the permanent magnet 103 in conjunction with the inner iron piece 105 and the outer iron piece 102. The magnetic induction mechanism 10 further has an induction magnetic field which is brought about by the induction coil 106. In other words, the permanent magnet 103 serves to lower the required intensity of the induction magnetic field, thereby resulting in reduction in consumption of energy by the induction coil 106. The spring 206 provides a recovery spring force enabling the engagement block 207 and action piece 209 to return to their original positions at the time when electromagnetic induction is terminated.

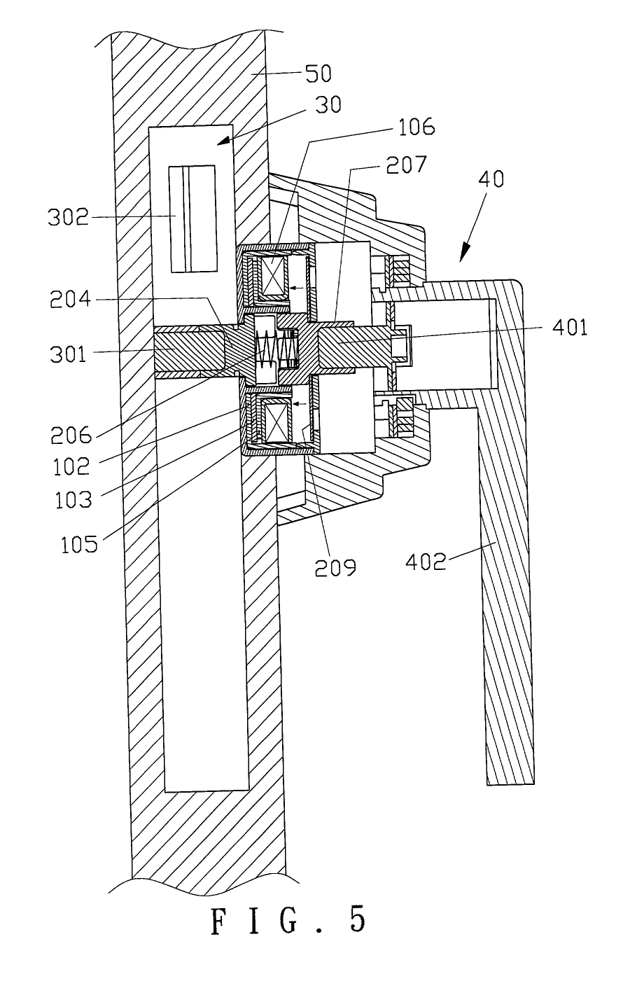

As shown in FIG. 5. the lock core mechanism 30 is mounted in the internal side of a door body 50 such that an insertion bolt 301 of the lock core mechanism 30 is fastened with the retaining block 204 of the clutch mechanism 20. The insertion bolt 301 is linked with a lock tongue 302. As a result, the retaining block 204 is linked with the lock tongue 302. The engagement block 207 is joined with a rotary shaft 401 of the rotation mechanism 40. The rotary shaft 401 is linked with a doorknob 402 which is mounted in the external side of the door body 50. As the electronic lock of the present invention remains in the locking state, the induction coil 106 is not provided with the electric current. In spite of the presence of the magnetic field brought about by the permanent magnet 103 in conjunction with the inner iron piece 105 and the outer iron piece 102, the magnetic field intensity is not strong enough to effect the action of the action piece 209 to result in the disengagement of the retaining block 204 with the engagement block 207. As a result, the lock core mechanism 30 is invalid. In the meantime, the doorknob 402 of the rotation mechanism 40 is idled.

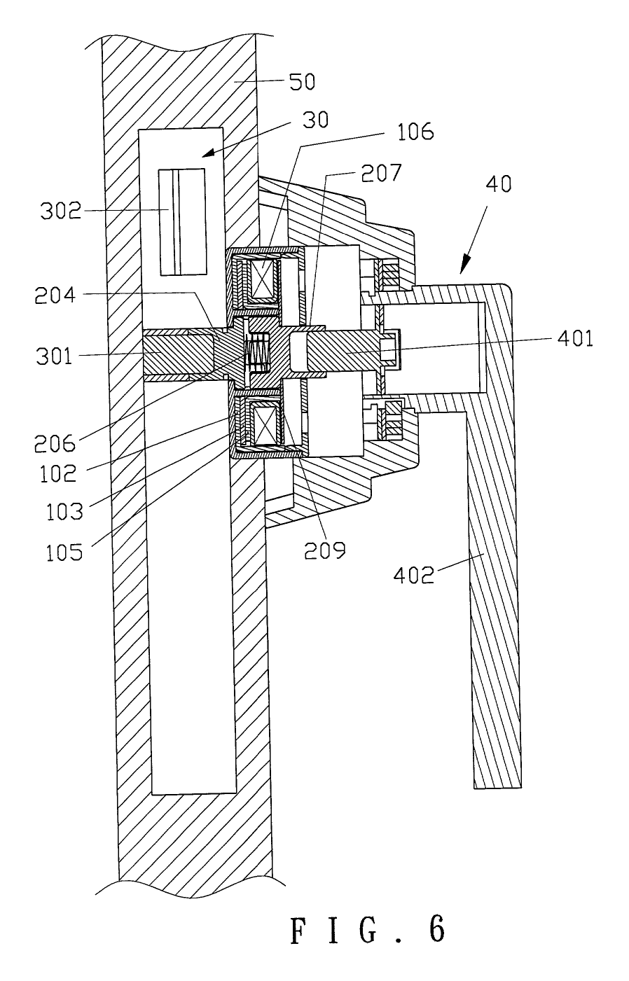

As illustrated in FIG. 6, when the electric current is made available to the induction coil 106, an induction magnetic field is brought about by the induction coil 106. The action piece 209 is put into action by the combined effort of the auxiliary magnetic field of the permanent magnet 103 and the induction magnetic field of the induction coil 106. As a result, the engagement block 207 is forced by the action piece 209 to become disengaged with the retaining block 204. The rotary shaft 401, the engagement block 207, the retaining block 204, the insertion bolt 301, and the lock tongue 302 are thus linked so as to enable the doorknob 402 to actuate the lock tongue 302. The electronic lock of the present invention is now in the unlocking state.

It must be noted here that the magnetic induction mechanism 10 and the clutch mechanism 20 of the present invention are compatible with other lock core mechanisms and rotation mechanisms, which are different in form from the lock core mechanism 30 and the rotation mechanism 40 of the present invention described above.

What is claimed is:

1. An electronic lock comprising a magnetic induction mechanism, a clutch mechanism, a lock core mechanism, and a rotation mechanism, said clutch mechanism being linked at one end with said lock core mechanism, and at other end with said rotation mechanism, said clutch mechanism being activated by said magnetic induction mechanism; wherein said magnetic induction mechanism is formed of a permeable outer iron piece, a permeable inner iron piece, a permanent magnet located between said permeable outer iron piece and said permeable inner iron piece for generating an auxiliary magnetic field, and an induction coil held by said permeable inner iron piece for generating an induction magnetic field; wherein said clutch mechanism is activated by a combined force of said auxiliary magnetic field and said induction magnetic field.

2. The electronic lock as defined in claim 1, wherein said clutch mechanism comprises an impermeable housing, a retaining block, an engagement block opposite in location to said retaining block, and an action piece held by said engagement block; wherein said magnetic induction mechanism is housed in said impermeable housing of said clutch mechanism such that said action piece of said clutch mechanism is activated by the combined force of said auxiliary magnetic field and said induction magnetic field, thereby resulting in engagement of said engagement block with said retaining block.

3. The electronic lock as defined in claim 2, wherein said clutch mechanism further comprises a spring which is located between said retaining block and said engagement block of said clutch mechanism for providing a recovery spring force enabling said engagement block and said action piece to return respectively to an original position thereof.

4. The electronic lock as defined in claim 2, wherein said clutch mechanism is linked at one end with the lock core mechanism such that said retaining block of said clutch mechanism is connected to an insertion bolt of the lock core mechanism, with the insertion bolt being linked with a lock tongue of the lock core mechanism; wherein said clutch mechanism is linked at other end with the rotation mechanism such that said engagement block of said clutch mechanism is connected to a rotary shaft of the rotation mechanism, thereby enabling said engagement block to be actuated by a doorknob of the rotation mechanism.
